(19) United States
(12) Patent Application Publication
(10) Pub. No.: US 2010/0057860 A1
(43) Pub. Date: Mar. 4, 2010

(54) CONFIRMATION AND ACKNOWLEDGEMENT OF TRANSMISSION RECEPTION

(76) Inventors: Donna M. Fry, Trinity, FL (US); Steven Christenson, Campbell, CA (US); Marcelo Oliveira, San Jose, CA (US); Mayank M. Singi, Milpitas, CA (US)

Correspondence Address: CAMPBELL STEPHENSON LLP, 11401 CENTURY OAKS TERRACE, BLDG. H, SUITE 250, AUSTIN, TX, 78758, US

(21) Appl. No.: 12/201,123

(22) Filed: Aug. 29, 2008

(51) Int. Cl. G06F 15/16; G06F 17/30

(52) U.S. Cl. 709/206; 707/102; 707/E17.044

(57) ABSTRACT

Systems and methods of conveying feedback concerning transmissions sent using a one-to-many protocol are disclosed. Such feedback includes information indicating whether a message was received by anyone, by whom, whether the message was accessed, and whether a receiver of the message has acknowledged the message. A receiver is configured to provide such feedback, either in response to receiving a request to send feedback, or automatically. The feedback is sent via the same communications channel the message was sent on, or via a different communications channel. A message's sender is informed that feedback has been received for a given message, and a searchable log is kept of the feedback.

### FIELD OF THE INVENTION

This application relates to telecommunications and, more particularly, to transmission feedback.

### BACKGROUND OF THE INVENTION

Telecommunication refers to the transmission of information using technology such as radio, telephones, or computers. Some telecommunications protocols do not have feedback mechanisms built in. For example, most multicast communication techniques do not have built in feedback mechanisms.

Multicast is an example of a one-to-many communication technique in which a sender transmits a message for simultaneous delivery to multiple receivers. Not requiring feedback means that a multicast sender need not know specific details of each receiver or potential receiver. Instead, a multicast sender can simply send a message once and it will be transmitted to those receivers who have chosen to receive messages from the sender.

However, not requiring feedback can be disadvantageous in a number of contexts. For example, consider a police dispatcher who sends a message summoning all available patrol cars to a crime scene. If the dispatcher does not receive a reply from any patrol cars, and in the absence of any built in feedback mechanism, the dispatcher may have no way to determine whether the message was received, heard, and will be complied with, i.e., whether any patrol cars heard the message and will proceed to the crime scene.

### BRIEF DESCRIPTION OF THE DRAWINGS

The present invention may be better understood, and its numerous objects, features and advantages made apparent to those skilled in the art by referencing the accompanying drawings.

FIG. 1 is a block diagram of a system in which feedback is provided for one-to-many network transmissions, according to one embodiment of the present invention.

FIG. 2 is a block diagram of a computing device which presents feedback to a user according to one embodiment of the present invention.

FIG. 3 is a block diagram of a computing device which implements a confirmation and acknowledgment module according to one embodiment of the present invention.

FIG. 4 is a block diagram of a device which monitors clients and provides feedback according to one embodiment of the present invention.

FIG. 5 is a flowchart depicting operation of a computing device which transmits messages and presents feedback to a user according to one embodiment of the present invention.

FIG. 6 is a flowchart depicting operation of a computing device that receives messages from a transmitter according to one embodiment of the present invention.

FIG. 7 is a flowchart depicting operation of a monitoring device according to one embodiment of the present invention.

FIG. 8 shows an example of a user display of a log which records feedback according to one embodiment of the present invention.

FIG. 9 shows several examples of payloads for RTP packets according to one embodiment of the present invention.

FIG. 10 shows how an RTCP report can be extended according to one embodiment of the present invention.

While the invention is susceptible to various modifications and alternative forms, specific embodiments of the invention are provided as examples in the drawings and detailed description. It should be understood that the drawings and detailed description are not intended to limit the invention to the particular form disclosed. Instead, the intention is to cover all modifications, equivalents and alternatives falling within the spirit and scope of the invention as defined by the appended claims.

### DETAILED DESCRIPTION

### Overview

A computing device connected to a network detects whether a message that was transmitted using a one-to-many protocol was received by one or more receiver computing devices. An indication of whether the message was received is generated and presented via an interface included in or coupled to the computing device.

### Description of Example Embodiments

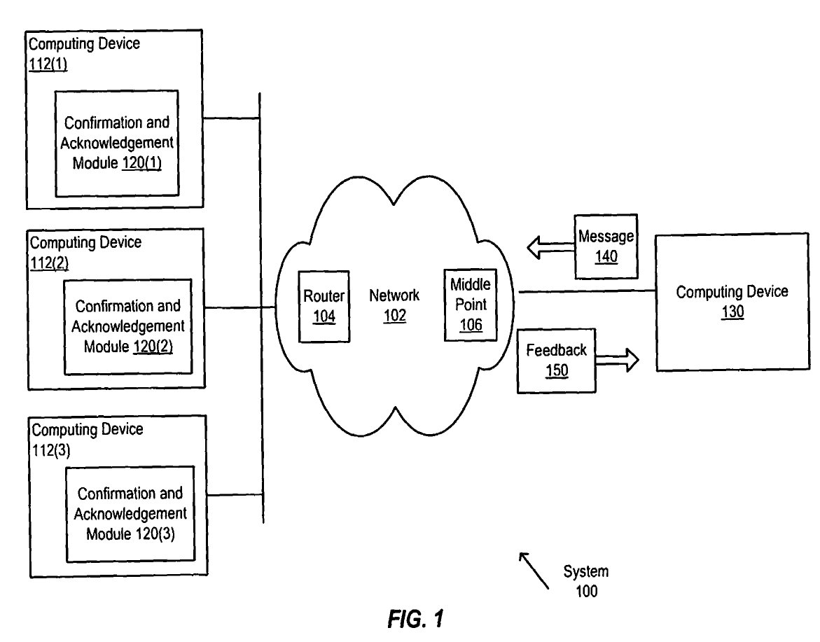

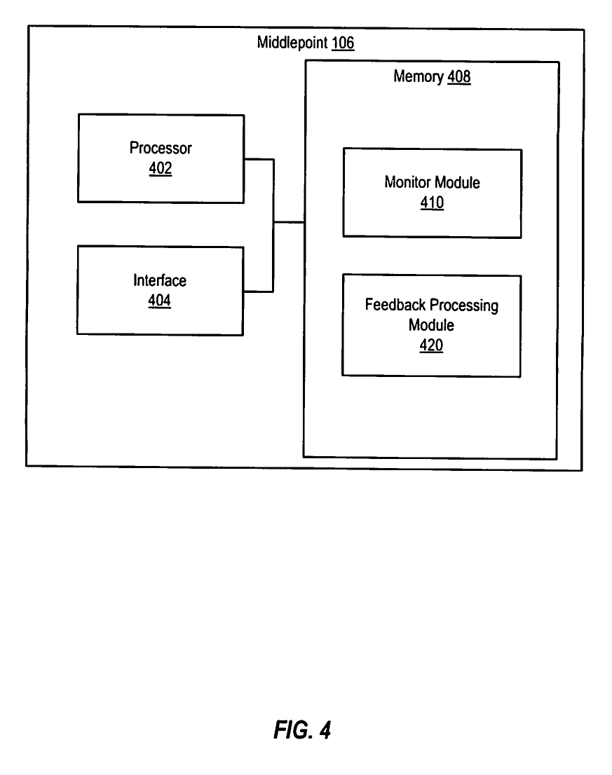

FIG. 1 is a block diagram of a system in which feedback is provided to a sender of a one-to-many transmission. As depicted in FIG. 1, system 100 includes network 102. Network 102 can include one or more Local Area Networks (LANs) and/or Wide Area Networks (WANs) such as the Internet. Network 102 can be implemented using various wireless links, coaxial cables, fiber optic cables, and the like. Network 102 also includes various network devices, such as router 104 and middlepoint 106, which are illustrated as examples of components of a network. The tern middlepoint denotes a device which is typically between a sender and a receiver in a network. Middlepoint 106 (discussed in more detail with reference to FIG. 4) may be any device, conference mixer, or forwarding entity that combines, concentrates or restreams (forwards) voice packets using communications hardware, such as a unified messaging platform or land mobile radio (LMR) gateway.

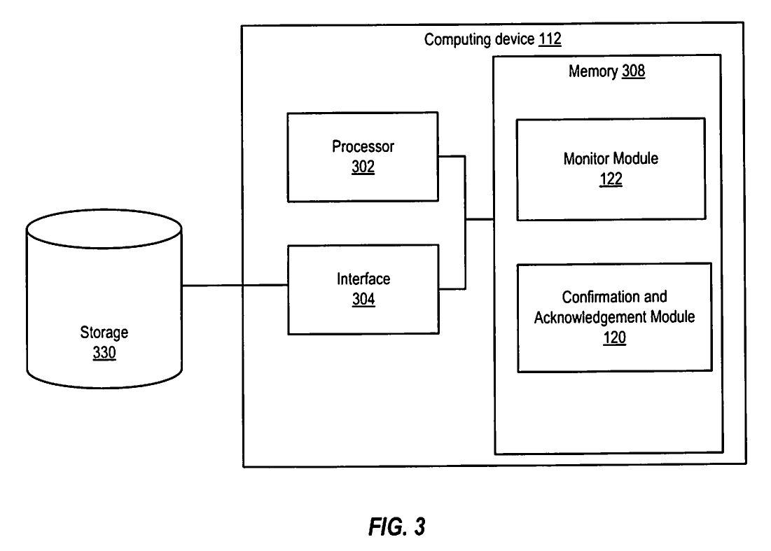

One or more computing devices 112(1)-112(3) (collectively referred to as computing devices 112, discussed in more detail with reference to FIG. 3), which are shown as including confirmation and acknowledgement modules 120(1)-120(3) (collectively referred to as confirmation and acknowledgement module 120), are connected to computing device 130 via network 102. Each computing device 112 may include one or more servers, personal computers, phones, laptop computers, personal digital assistants, or other computing devices that are capable of receiving a one-to-many transmission. Each computing device 112 may be an end-user device that is an endpoint for a one-to-many transmission. Alternatively, each computing device 112 may be an intermediate element of a network. Each computing device 112 can receive messages, monitor other computing devices, and generate and transmit feedback information. Each computing device 112 is also referred to herein as a receiver.

In the illustrated embodiment, confirmation and acknowledgement modules 120(1), 120(2), and 120(3) are shown as being included in computing devices 112(1), 112(2), and 112(3), respectively. It is to be understood that confirmation and acknowledgement modules 120 may be implemented separately from computing devices 112 in alternative embodiments. Each confirmation and acknowledgement module 120 determines what type of feedback is appropriate, if any, generates the feedback, and transmits the feedback onto network 102. This is typically done in response to receiving a message, for example, via network 102, but each confirmation and acknowledgement module 120 may also provide feedback when no message is received.

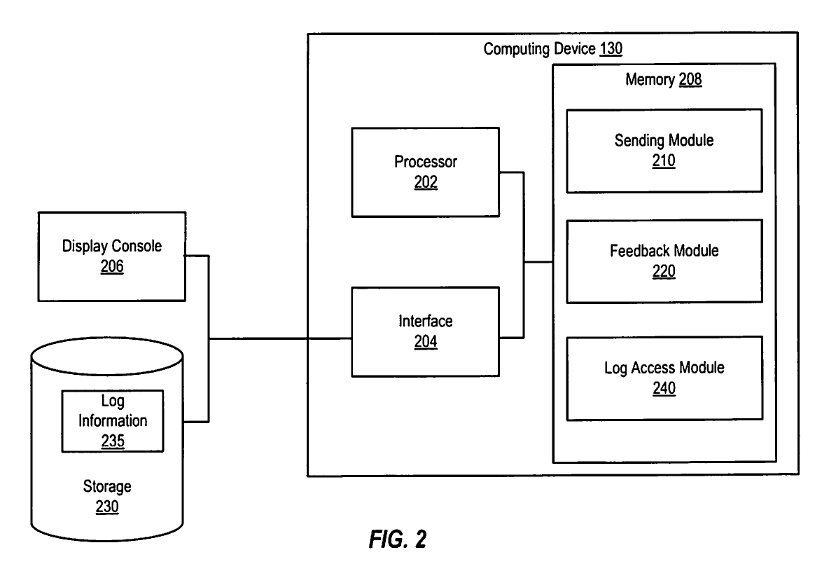

Computing devices 112(1), 112(2), and 112(3) communicate with computing device 130 via network 102. Computing device 130 is shown as sending a message 140 and receiving feedback 150 via network 102. Computing device 130 (discussed in more detail with reference to FIG. 2) can include one or more servers, personal computers, phones, laptop computers, personal digital assistants, or other computing devices that are capable of transmitting a one-to-many message. Computing device 130 performs a number of functions, including sending messages, requesting feedback, receiving and processing feedback, displaying feedback information, and/or recording and storing feedback information. Alternative embodiments include various combinations of some or all of these capabilities. While computing device 130 is shown as a single device, it is understood that tile various functions implemented via computing device 130 can be distributed among several such devices and one or more discrete elements coupled thereto, for example, displays. Computing device 130 is also referred to herein as a sender.

Message 140 is typically sent using a one-to-many transmission protocol, such as multicast or broadcast. Message 140 can include audio, video, still images, and/or data. Feedback 150 includes information regarding the reception and disposition of a message, for example, message 140.

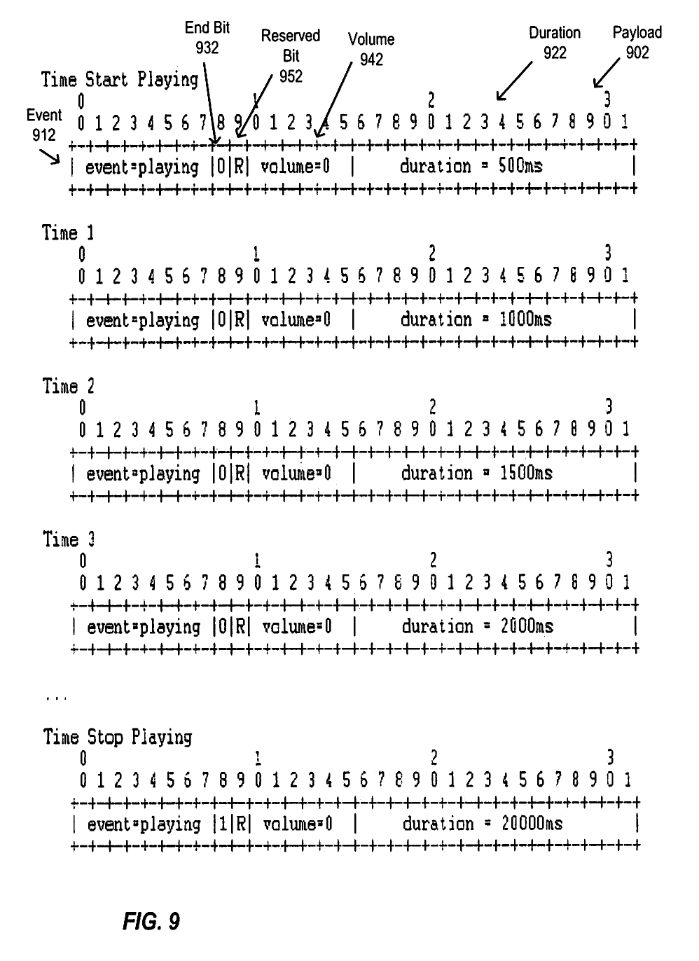

In one embodiment, an administrator of system 100 can configure system 100 to use real-time transport protocol (RTP) messages to request and transmit feedback, as described in more detail with respect to FIG. 9. A request for feedback can be encoded as a dual-tone multifrequency tone or event. For example, an administrator can select an event to use as the request and configure the sender to embed the selected event in messages requesting feedback. Similarly, the receiver can be configured to detect the selected tone within the received message and to interpret that tone as a request for feedback. Receivers can be configured so that the receivers can translate the tone or event to understand that the tone or event is a request for feedback, or that the tone or event requests a specific type of feedback, if multiple events are used to request respective types of feedback. Depending on the type of feedback desired, senders can select one or more custom tones or events to embed in an outgoing message. By doing so, the outgoing message is modified to request a specific type of feedback. In one embodiment, the tones or events used comport with the standard described in RFC 2833. See H. Schulzrinne & S. Petrack, “Request For Comments 2833—RTP Payload for DTMF Digits, Telephony Tones and Telephony Signals,” (2000).

When message 140 is received by a receiver, the receiver can send feedback in another message in response to the request. For example, if feedback 150 contains an RTP message, a tone or event can be embedded in the RTP message in feedback 150. The tone or event can be used to encode information. A message containing such a tone or event can be configured such that a user of a sending or receiving device is unaware of the presence of the tone or event. That is, the feedback request and return can be configured such that the tone or event is not noticeable to a user and the user's experience is unaffected.

An administrator can configure each receiver to handle feedback in a variety of ways. In some embodiments, a receiver provides feedback only when feedback is requested by a sender. In other embodiments, feedback need not be requested by a sender. Instead a receiving device, such as computing device 112, automatically provides feedback for messages the receiver receives. For example, a receiver can be configured to always transmit feedback when a message is received.

When there are many receivers, it may be desirable to configure feedback handling so that the number of feedback messages is less than the number of receivers. For example, a receiver can be configured to transmit feedback after a randomized interval of silence, or only if no other receivers transmit feedback. In order to determine whether other receivers are providing feedback for a message, a receiver can monitor other receivers in a system. This monitoring can be done by directly monitoring other receivers, or can be done by monitoring a communication channel (e.g., a LAN). For example, if all traffic for a given set of receivers goes through a particular network element (e.g., a particular gateway), a receiver can be configured to monitor that element to detect whether feedback has been provided for a given message. If a receiver detects that feedback has not been provided by any of the receivers of a given message, that receiver can then send feedback. If, on the other hand, feedback is already sent for a given message, the receiver can avoid sending feedback. Each receiver can be configured to wait a specified period of time to determine if other receivers are providing feedback. The problem of multiple receivers simultaneously responding to a message can be avoided by configuring receiver to wait different amount of time than the other receivers a message is sent to.

In another embodiment, one specific receiver is configured to transmit feedback, and the other receivers a message is sent to are configured to not transmit feedback. This avoids the need for a receiver to monitor other receivers to determine if feedback is being provided. Instead, a particular receiver is configured to provide feedback for a group of receivers and the other receivers are configured to not provide feedback. An example of this is when receivers in a group have different authority levels, such as in a company, a request may be sent to an entire group, but only a computing device used by the group leader is configured to provide feedback, as only the group leader's response is desired or allowed.

In another embodiment, a middlepoint, that is an entity in the network that is able to inspect and may optionally be required to retransmit (restream) communication packets (e.g., a router or a voice over IP conferencing bridge) generates and transmits feedback based on the feedback messages it observes from individual receivers. In order to do so, the middlepoint must monitor receivers to determine which of the receivers has received a message. This may be done by actively detecting when a feedback message is transmitted by a receiver. In alternative embodiments, the middlepoint may use feedback provided by receivers that is not contained in normal feedback messages to determine which receivers have received a message. In the case where the middlepoint monitors feedback, the middlepoint can intercept and aggregate feedback sent by receivers. This reduces network congestion and may facilitate providing feedback to a sender in a more useful format.

The previous embodiments disclose providing feedback using in-band methods, i.e. feedback is transmitted along the same communication channels as the message to which the feedback pertains. In alternative embodiments, feedback is sent using an out of band method. Examples of out-of-band methods which can be utilized to provide feedback include any of a variety of well-known instant messaging, file transfer, or email protocols. Examples of out-of-band mechanisms which can be utilized to provide feedback are real-time transfer control protocol RTCP reports, SIMPLE (session initiation protocol for instant messaging and presence leveraging extensions), Jabber, SFTP (secure shell file transfer protocol), or SMTP (simple mail transfer protocol), to name a few.

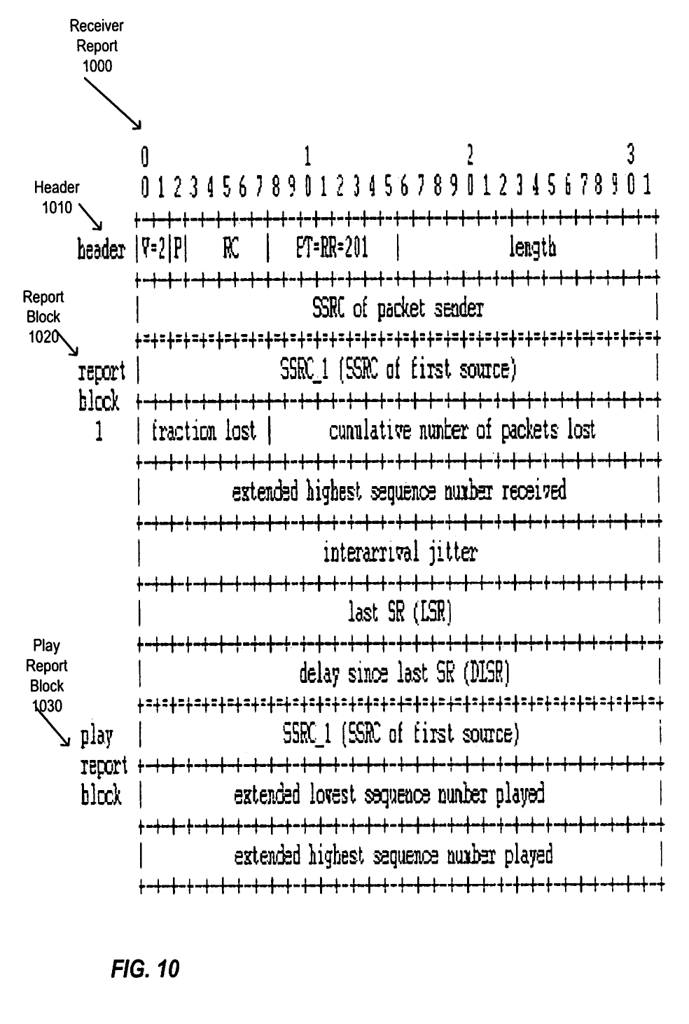

In one embodiment, feedback is provided using RTCP reports. RTCP receiver reports (RRs) ordinarily carry mainly usage statistics, and are used to insure quality of service in a network environment. According to one embodiment, a system administrator can configure the system such that RRs are modified to carry feedback information, as discussed with respect to FIG. 10. For example, feedback 150 could be an RR containing feedback information such as the feedback information discussed below. RTCP sender reports (SRs) are similar to RRs, except that they are sent by senders. In one embodiment, a system administrator can configure the system such that SRs are modified to carry a request for feedback information. Sending feedback using RTCP reports works best when the number of users is small, due to the fact that the frequency of RTCP reports is automatically reduced as the number of participants increases.

A request for feedback can specify how the feedback is to be transmitted, i.e., in-band or out-of-band. Feedback for a given message may be provided using an in-band mechanism, e.g., RTP messages, an out-of-band mechanism, e.g., RTCP reports, hypertext transfer protocol (HTTP) messages posted to a common server, or some combination of in-band and out-of-band mechanisms.

As discussed above, feedback, such as feedback 150, can be generated and transmitted in a number of ways. Feedback can also include a variety of information and types of information. Consider the case where a sender sends a message to potentially numerous receivers. The sender may wish to know whether the message was received by any receivers. An indication that no receivers got the message could indicate a problem with the sender's ability to send messages, or could indicate that no receivers are available to receive the message. The sender may also want to know which receivers received the message. Information about specific receivers can include information such as the receiver's name, title, location, level of authority within an organization, and the like. Tile sender may wish to know not only that a message reached a certain receiver, but whether the message was accessed by the receiver. For instance, in the case of an audio message, a sender may wish to know whether the message was played in part or in its entirety, or whether the message was partially or entirely unusable due, for example, to transmission problems. The sender may also wish for a response containing information concerning the receiver's evaluation of the message, such as whether the user agrees or disagrees with the content. For example, if the message is a request for the receiver to perform an action, the sender may desire an indication of whether the receiver will or will not perform the action. For example, if the message is a message dispatching an emergency response team to a particular location, feedback may be provided indicating that the emergency response team has received and heard the dispatch and that the team is en route or that the team is unable to comply with the request. In this example, computing device 112 may correspond to a computer in an emergency vehicle. Computing device 130 may correspond to a dispatch station. The types of feedback described herein are merely examples of information that may be transmitted, for example, using feedback 150.

FIG. 2 is a block diagram of computing device 130 showing how a sending module 210 and a feedback module 220 can be implemented in software. As shown in FIG. 2, computing device 130 includes one or more processors 202 (e.g., microprocessors, PLDs (Programmable Logic Devices), or ASICs (Application Specific Integrated Circuits)) configured to execute program instructions stored in memory 208. Memory 208 can include various types of RAM (Random Access Memory), ROM (Read Only Memory), Flash memory, MEMS (Micro Electro-Mechanical Systems) memory, and the like. Computing device 130 also includes one or more interfaces 204. Processor 202, interface(s) 204, and memory 208 are coupled to send and receive data and control signals by one or more buses or other interconnects. Interface 204 is coupled to display console 206 and storage 230. Interface 204 can also include an interface to a network (e.g., network 102 of FIG. 1) for use in sending messages and receiving feedback.

Storage 230, which contains log information 235, can include one or more tapes, hard drives, compact discs (CDs) or digital video discs (DVDs), and the like, as well as one or more arrays of individual storage devices (e.g., an optical storage jukebox, a “Just a Bunch of Disks” (JBOD) array, or a Redundant Array of Independent Disks (RAID) system).

In this example, program instructions executable to implement sending module 210, feedback module 220, and log access module 240 are stored in memory 208. It is noted that the program instructions and/or data executable to implement sending module 210, feedback module 220, and log access module 240 can be stored on various computer readable storage media such as a memory (e.g., RAM (Random Access Memory)). In some embodiments, such software is stored on a computer readable storage medium such as a CD (Compact Disc), DVD (Digital Versatile Disc), hard disk, optical disk, tape device, floppy disk, and the like. In order be executed, the software is loaded into memory from another computer readable storage medium. The instructions and/or data can also be transferred to a computing device for storage in memory via a network such as the Internet or upon a carrier medium. In some embodiments, the instructions and/or data are conveyed using a carrier medium such as a network and/or a wireless link upon which signals such as electrical, electromagnetic, or digital signals.

Sending module 210 sends messages and requests feedback. Sending module 210 may also specify certain receivers to provide feedback. For example, a user may only wish to receive feedback from high-level users, or from a particular user within an organization. For example, a request for feedback, such as an RTP message embedded in outgoing media, can specify that only receivers who meet certain criteria should send feedback. When a receiver receives the request, the receiver determines whether the criteria are satisfied and feedback should be sent. For example, if the request for feedback specifies that only group managers, or the head of a certain department should reply, a receiver who does not fulfill that specification does not transmit feedback. Alternatively, the sender or some other network element can be configured to store the criteria specified in an outgoing message and to compare incoming feedback with the criteria. If incoming feedback does not meet the requirements, for example, the feedback is not from a group manager, the feedback is filtered out, meaning information regarding the feedback is not stored in storage 230 or presented to a user of computing device 130.

Feedback module 220 receives and processes feedback. Feedback module 220 then provides feedback information to interface 204 for presentation via display console 206 and storage in storage 230. Feedback information can be stored in a searchable database, allowing a user to search, for example, by keyword

Feedback module 220 may need to extract, translate, or format incoming feedback, depending on the feedback mechanism used. In the example where feedback is provided using tones or events embedded in an RTP message, for example, feedback module 220 extracts the events from the RTP message and converts the events to a format that can be stored in storage 230. Feedback module 220 can then transfer the converted feedback information to interface 204 so that the information is stored in storage 230 in a format that is readily accessible by a user of computing device 130.

In the case where computing device 130 receives feedback from more than one source, feedback module 220 can aggregate the feedback before the feedback is stored and presented to a user of computing device 130. Feedback module 220 can analyze the feedback and compile statistics concerning the feedback to make the feedback more useful to senders. For example, a sender may be interested to know how many total receivers received and accessed a message and how many of those were above a certain organizational authority level. Feedback module 220 can be configured to automatically generate such information, or other information which may be useful.

Display console 206 presents various types of information relating to feedback received or expected at computing device 130. Both audible and visual information can be presented. Notification may be visually displayed using various lights, LCDs (liquid crystal displays), LEDs (light emitting diodes), and the like. In one embodiment, various colors of LEDs and various shapes of an LED display have meaning. For example, a transmit indicator may change from a blinking red dot to a lightning bolt to indicate that feedback has been received indicating a message was received by at least one receiver. An LED display in the shape of an ear may turn green to indicate a message was accessed, may be orange to indicate partial access of a message, or may be red to indicate that a message was not accessed. Feedback information may also be presented using a pop-up window on a computer screen which displays feedback information. The pop-Lip contains (optionally) the name or ID of a receiver, and indicates not only that a message was received, but also indicates whether the message was accessed, and also whether the message was acknowledged. The various examples of audio and visual displays are examples of user interfaces

Additionally (or alternatively), a speaker (not shown, but which may be included in or coupled to display console 206) can play tones, beeps, recorded messages, and the like to present feedback information to a user. Different tones are used to indicate transmission, reception, and acknowledgement of a message. Display console 206 can also provide feedback information without having received a feedback response. For example, a warning icon can be used to notify a sender that no potential receivers are available to receive messages.

As noted, computing device 130 is connected to storage 230, which stores information about sent messages and received feedback. For each message sent, or each feedback message received, sending module 210 or feedback module 220 uses interface 204 to store log information 235 in storage 230. Log information 235 includes such information as the time the message was sent and received, source, destination, and the like. Such information is accessible by log access module 240. Example log information is shown below.
Msg 521 by DISPATCH to “AllCountyAlert”: Initiated 12:23:01.0052 UTC completed 12:23:04.845 Received by XYZZY at 12:23:04.0140 UTC Played by XYZZY at 12:23:04.0190 UTC Suppressed by SILENCEPLEASE at 12:23:05.0021 UTC Received by PLUGH at 12:23:05.888 UTC DENIED by XYZZY at 12:23:07.1446 UTC Played by PLUGH at 12:23:06.0021 UTC
Msg 523 by DISPATCH to “SoCountyWeatherUpdate”: Initiated 12:33:44.0002 UTC completed 12:33:45.845 UTC

Log information may be aggregated or summarized, for example, as follows:
#521 12:23:01 DENIED
#523 12:33:44 NOT RECEIVED
#521 12:23:01 3 Received: 1 Denied, 0 Affirmed, 2 Unacknowledged, 2 Played
#523 12:33:44 0 Received: 0 Denied, 0 Affirmed, 0 Unacknowledged, 0 Played

Log access module 240 is used to present information to a user of computing device 130 via display 206, for example. Log access module 240 organizes log information 235 into entries. Entries correspond to a message and can be displayed using color coding, or including flags to indicate various information about the message, for example, reception and acknowledgement of the message.

Log access module 240 and log information 235 can be used to determine when messages were sent and when feedback was received. For instance, a list of receivers of a given message and when each receiver received the message can be recorded in log information 235. Log information 235 can also include detailed information, such as whether a message was accessed by a receiver, the authority level of the receiver and the like. A user can access log information 235 via log access module and perform various searches. The user can also select what information the user wishes to view. For example, a user can use log access module 240 to request a list of all messages sent during a given time period for which feedback indicating assent was received from a group manager. Or, the user can request a list of all feedback received by a certain receiver.

Log information 235 can be used for forensic purposes. For example, if a user wishes to know which receivers received and acknowledged a given message, the user can access log information 235 via log access module 240. The user can specify the message or other criteria desired to return a list of entries which match those criteria. Log information 235 can also be used to troubleshoot a network. For example, log access module 240 can be used to analyze log information 235 to determine that messages sent on a particular communication channel are only received at certain times, and are dropped at other times. That information can be compared with information about a specific network to find out what the problem is.

While computing device 130 has been described as a sending device, computing device 130 can also be a receiver. For example, computing device 130 may send a message to a receiver, and await feedback for that message. The receiver may send a reply message and request feedback indicating that computing device 130 received the reply. In such a case, computing device 130 can be configured to provide feedback to the original receiver.

FIG. 3 is a block diagram of a computing device 112 showing how a monitor module 122 and a confirmation and acknowledgment module can be implemented in software. As shown in FIG. 3, computing device 112 includes one or more processors 302, memory 308, one or more interfaces 304, and storage 330 coupled by one or more buses or other interconnects. These elements are similar to those shown and described in detail in relation to FIG. 2.

Confirmation and acknowledgement module 120 provides feedback generation and transmission functionality for computing device 112. Messages typically are received from a network such as network 102 of FIG. 1 via a network interface included in interface 304. Received messages are processed, which can include various operations such as removing headers, decryption, error checking, and format conversion. Any feedback requests embedded in a received message are also extracted and processed. For example, if a request for feedback is encoded in a tone or event embedded in media, the tone or event is filtered out such that the user's experience is unaffected. The feedback request is then responded to. This includes processing the request to determine what type of feedback or what method of transmission is requested. In the example where the feedback request comprises information encoded in a tone or event (e.g., an event as described in RFC 2833), the event may specify a method by which feedback is to be returned. For example, the event may be translated to determine that feedback is to be returned using some method other than a tone or event, for example, an RTCP receiver report. Confirmation and acknowledgement module 120 interprets the feedback request, (e.g., using a lookup table included in confirmation and acknowledgement module 120), and generates feedback according to the specifications in tile request. Confirmation and acknowledgement module 120 is configured to provide feedback according to any one or more of the methods referred to above, including tile in-band and out-of-band methods. Generating feedback may include encapsulating feedback content into a transmittable format, addressing the feedback message, encrypting the message, and then transferring the feedback message to interface 304 for output onto a network, for example network 102, by a network interface included in interface 304.

Confirmation and acknowledgement module 120 communicates the content, or media, contained in a received message to interface 304. Interface 304 transfers the message content to storage 330, and also causes the message to be made available for playout, for example via speakers or a display screen (not shown) included with computing device 112. The messages sent to storage 330 can be organized and made accessible by a storage manager. Messages can be stored, for example, in a searchable database. A user of computing device 112 can search for messages, for example, by keyword, intended receiver, date, or priority. For example a user may wish to view all high-priority messages received in a certain period of time. Other messages may be viewed significantly later than the messages are received. The user can preferably query storage 330 (via a storage manager) to retrieve only those messages which match those criteria. The user can then select from among the retrieved messages which to play.

Confirmation and acknowledgement module 120 also communicates with interface module 304 to detect when messages are played. When a message is played or accessed, for example, when a video is watched using a display screen, interface 304 sends a notification to confirmation and acknowledgement module 120. Confirmation and acknowledgement module 120 then generates and transmits feedback indicating playout of the message.

A user of computing device 112 can acknowledge a received message either by affirming or denying the message. For example, the user may select and view a video message containing instructions. If the user does not intend to comply with the instructions, for example, if the user is unable or unwilling to follow the instructions, the user can indicate that the message is denied. Such indication can be provided by, for example, selecting “Deny” on a menu of options which is displayed at the end of the message. Indication of the user's acknowledgement is captured by interface 304 and transmitted to confirmation and acknowledgement module 120. Confirmation and acknowledgement module 120 then generates feedback containing the acknowledgment. Confirmation and acknowledgement module 120 may also transmit information such as the identity of computing device 112 or a user of computing device 112, the authority level of the user, or other such information. Such information may be stored in a system profile, or a user profile loaded when the user logs in to computing device 112. Confirmation and acknowledgement module 120 can extract that information and transmit it along with other feedback information.

Feedback indicating receipt, playout, and acknowledgment can be sent separately, as each event occurs, or can be sent all together. That is, confirmation and acknowledgement module 120 may hold feedback indicating receipt of a message until the message is played and/or acknowledged. Confirmation and acknowledgement module 120 may then send all feedback together in a single message. Each type of feedback can be sent using a different method. For example, feedback indicating receipt of a message can be sent using a customized RTP message and feedback indicating the same message was affirmed can be sent by encoding feedback information in one or more tones or events. Additionally, confirmation and acknowledgment module 120 may not provide feedback for each message received, but may send a single feedback message for a several received messages. This is generally applicable when several messages are received which are part of a single group or stream.

Computing device 112 also includes monitor module 122, which has the ability to monitor other receivers. Monitor module 122 can detect whether the other receivers send feedback. Monitor module 122 can also detect what authority level the receivers have. For example, a receiver could be required to register with an authority level and ID when the user logs into a computing device, such as computing device 112. Monitor module 122 could be connected to a network device assigned to monitor the network topology and could therefore know what receivers are signed in and available to receive messages, and the authority level of those receivers.

Another way monitor module 122 may detect feedback sent by other receivers is that monitor module 122 includes the capability to poll other receivers. Such polling allows monitor module 122 to detect whether a given receiver has responded with feedback to a given message.

Monitor module 122 can communicate with confirmation and acknowledgement module 120 to notify confirmation and acknowledgement module 120 which receivers, if any, have sent feedback. The behavior of confirmation and acknowledgement module 120 can be configured by an administrator such that confirmation and acknowledgement module 120 sends feedback only if no other receivers do or if no high-level receivers do, as determined by information generated by monitor module 122. A receiver monitoring other receivers can be configured by an administrator to send feedback if, after a certain period of time, feedback has not been sent by another receiver. The amount of time a receiver is configured to wait to detect if feedback is sent by other receivers depends on the characteristics of the network and computing devices 112, and is determined by an administrator. For example, computing devices 112 may be configured such that they must send feedback, if at all, within 200 milliseconds of receiving a message.

Monitor module 122 is excluded from some embodiments, for example if feedback is sent by all receivers, of if monitoring is performed by an intermediate network element, such as middlepoint 106 of FIG. 1.

While computing device 112 is described as receiving a message and transmitting feedback, computing device 112 can also be configured to transmit a messages and process feedback for the message. For example, when computing device 112 receives a message, computing device 112 may be configured to send feedback for the received message. However, a user of computing device 112 may wish to send a message, either to the sender of the received message, or to another entity. In that case, computing device 112 can transmit a message. Computing device 112 can also request feedback for the message. Computing device 112 can also receive and process feedback from one or more receivers of the message computing device 112 sent.

FIG. 4 is a block diagram of a middlepoint 106, such as middlepoint 106 of FIG. 1, showing how a monitor module 410 and feedback processing module 420 can be implemented in software. As shown in FIG. 4, middlepoint 106 includes one or more processors 402, memory 408, and one or more interfaces 404 coupled to send and receive data and control signals by one or more buses or other interconnects. Interface(s) 404 can also include an interface to a network (e.g., network 102 of FIG. 1) for use in monitoring feedback and messages sent on the network. These elements are similar to those shown and described in detail in relation to FIG. 2.

Monitor module 410 monitors receivers. This can be accomplished in a variety of ways. In one embodiment, middlepoint 106 (shown in FIG. 4) is an intermediate network element responsible for making periodic reports on the health of the network. For example, middlepoint 106 can be a land mobile radio (LMR) gateway, which sends periodic acknowledgments and reports to a sender. The reports can contain an indication of messages sent by the sender that the gateway has forwarded. The sender can assume that messages forwarded by the gateway reach a receiver. Thus the gateway's reports act as feedback indicating that messages are being received.

In another embodiment, middlepoint 106 is connected to the same LAN as the sender and receiver, and thus has access to the same messages and feedback. When middlepoint 106 receives feedback, for example, from a computing device 112 of FIG. 3, feedback processing module 420 can aggregate the feedback with feedback provided by other computing devices on the LAN and provide a sender with a consolidated feedback report.

Middlepoint 106, can use polling to monitor receivers For example, a receiver may periodically poll other receives to determine whether they have received or provided feedback for a given message. An alternative monitoring technique is the use of listening threads. For example, middlepoint 106 can establish a listening thread on a given communication channel. Thus the middlepoint detects messages and feedback transmitted on the given channel. Alternative methods of monitoring are contemplated.

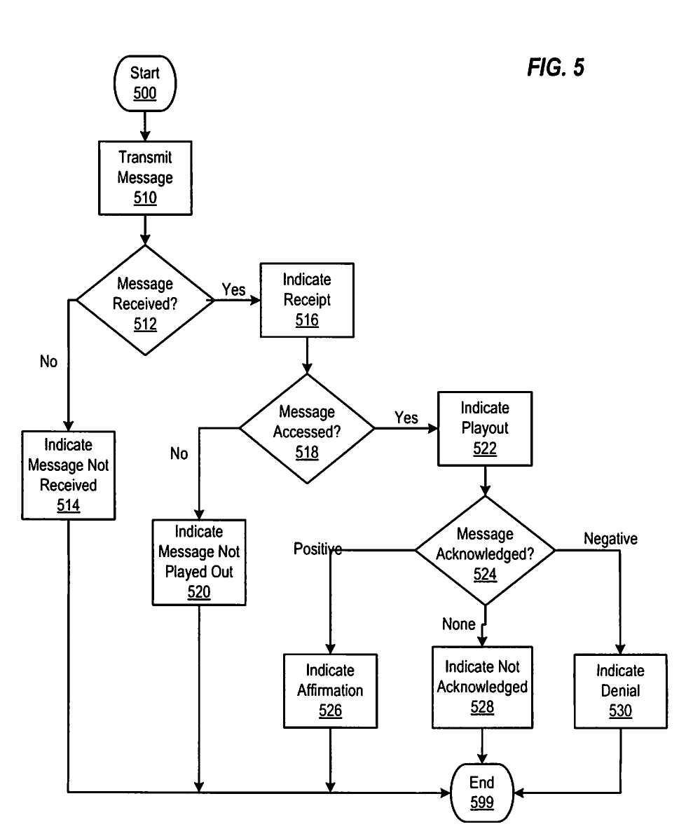

FIG. 5 is a flowchart showing the operation of computing device which transmits messages and presents feedback to a user, such as computing device 130 of FIG. 1. The method of FIG. 5 begins with a transmit message operation (operation 510). A message can be transmitted by a sending module (e.g., sending module 210 of FIG. 2). The transmitted message consists of one or more types of information, such as audio, video, still image, or data. The message can also include a feedback request. Transmitting a message involves generating a message and causing the message to be output via a network interface (e.g., interface 204 of FIG. 2), onto a network (e.g., network 102 of FIG. 1). Transmitting a message can include encapsulating media into a message format that can be transmitted over a network, addressing the message, breaking media to be transmitted into multiple parts, and applying encryption and other security measures. Transmitting a message can also include embedding a request for feedback in an outgoing message, or otherwise transmitting a request for feedback for an outgoing message (e.g., by sending another message, such as an RTCP SR). Transmitting a message is performed in response to a user wishing to send media to one or more receivers, or one or more receivers desiring access to some media accessible by the user.

Once a message is transmitted, the process of FIG. 5 proceeds to operation 512, where it is determined whether feedback has arrived indicating that the message was received at a computing device. The determination of whether feedback was received can be made by a feedback module included with the computing device. In one embodiment, feedback is expected in response to a request for feedback. The failure to receive a feedback message within a prescribed time acts as feedback indicating that a transmitted message was not received. In this determining operation, information indicating the number of receivers and the identities and levels of authority of the receivers may also be collected by the feedback module. This information is extracted from a received feedback message and can be placed in storage and displayed via a display console. If feedback is detected indicating the message was received, the method of FIG. 5 proceeds to operation 516, an indicate receipt operation.

When feedback indicating a message was received arrives at a feedback module, the feedback module processes the message. Processing received feedback can include verifying and removing headers, decrypting the received data, and error checking. The feedback module can also translate the received feedback, for example, by consulting a table or key indicating whether the message was received intact, with errors, and/or in a timely fashion. The processed feedback information can then be presented to a user via a display console. The processed feedback data may also be placed in storage.

If no feedback message is received, or if feedback is received indicating the message did not reach a receiver, the method of FIG. 5 proceeds to operation 514, where an indication that the message was not received is presented to a user. To determine that no feedback was received, a feedback module may wait a period of time. How long a feedback module waits can be configured by an administrator. Alternatively, a device monitoring a receiver (e.g., middlepoint 106 of FIG. 1), may detect that a message sent to a receiver(s) did not reach the receiver and send a feedback message to the sender, where it is received by a feedback module. A display console indicates that no feedback was received for a message, for example, by illuminating a red LED. Such an indication informs the sender that the message may need to be resent, or that there may be no receivers available, or that there may be a problem with the network. The feedback module communicates the feedback information to data storage to be stored.

If feedback is received indicating that a transmitted message was received by at least one receiver, the receipt is indicated to a user at operation 516, and the method of FIG. 5 proceeds to operation 518, where it is detected by a feedback module, whether the message was accessed, or played out, by a receiver. In the case of an audio message, if a receiver listens to the audio message, or the audio message is played through, for example, a speaker in such a way as to be audible, the message is considered as having been accessed, or played out. It is possible that the message is played through a speaker, but the volume is turned all the way down or set to mute. Preferably, the unheard audio message is not classified as having been played out. The feedback module sends information indicating whether a message was played out to a display console and storage. If feedback indicates that the message was played out, the method of FIG. 5 proceeds to operation 522, where the display console indicates the message was played out, for example, by illuminating a green LED, or an LED display shaped like an ear. If feedback indicates the message was not played out, the flow proceeds instead to operation 520, where the display console indicates that the message was not received, for example by illuminating a red LED. In both cases, the feedback information is placed in data storage.

If feedback is received indicating a message was played out, the method of FIG. 5 proceeds to operation 524. At operation 524, feedback is detected by a feedback module indicating whether the message was acknowledged. Possible acknowledgements include a positive acknowledgment (an affirmation) indicating that the receiver agrees, or will comply, with the message, and a negative acknowledgment (a denial) indicating that the receiver disagrees, or will not comply, with the message. Alternatively, it is possible that no acknowledgment is received for a message. Feedback indicating whether an acknowledgment is received, and if so what type, is passed from the feedback module to a display console and to data storage. If feedback indicates that the message was affirmed, the method of FIG. 5 proceeds operation 526, where the display console indicates the message was affirmed, for example, by illuminating a green LED. If feedback is received indicating that the message was denied, the method of FIG. 5 proceeds to operation 530, where the display console indicates the message was denied, for example, by illuminating a red LED. If neither is received, the method of FIG. 5 proceeds to step 528, where the display console indicates the message was neither affirmed nor denied, for example, by illuminating an orange LED. The feedback module communicates information indicating whether the message was acknowledged to data storage, where the information is stored.

The stored information is added to a body of information (e.g., log information 235) which can be used to construct a log. The information is added by, for example, a storage manager (not shown) included with the data storage facility. It is understood that the storage manager need not wait until the end of the flow to store the information for each operation, but may store the log information for each operation as the operation occurs.

As an example of the method of FIG. 5, consider an emergency response dispatcher sending a message dispatching an emergency response team to the site of an emergency. The message is downloaded into a computer onboard an emergency response vehicle. This download constitutes reception of the message, and feedback is generated by the emergency response vehicle computer indicating the message was received. It is likely that the emergency response vehicle receives more than one message. Tile received messages can be displayed, for example, in a list on a display console included with the emergency response computer. When an emergency response team member selects the dispatch message to display from a list of pending messages and the message is presented to the team member, feedback indicating the message was played out is generated. The message may be a text based message, a recorded audio message, or the like. If the emergency response team member elects to respond, for example, by replying that the emergency response team will accept the call and proceed to the site directed in the dispatch order, feedback indicating that the message was affirmed is generated and transmitted to feedback module 220. If the emergency response team member elects to respond that the emergency response team will not accept the call and is unable to proceed to the site directed in the dispatch order, feedback indicating that the message was denied is generated and transmitted to feedback module 220.

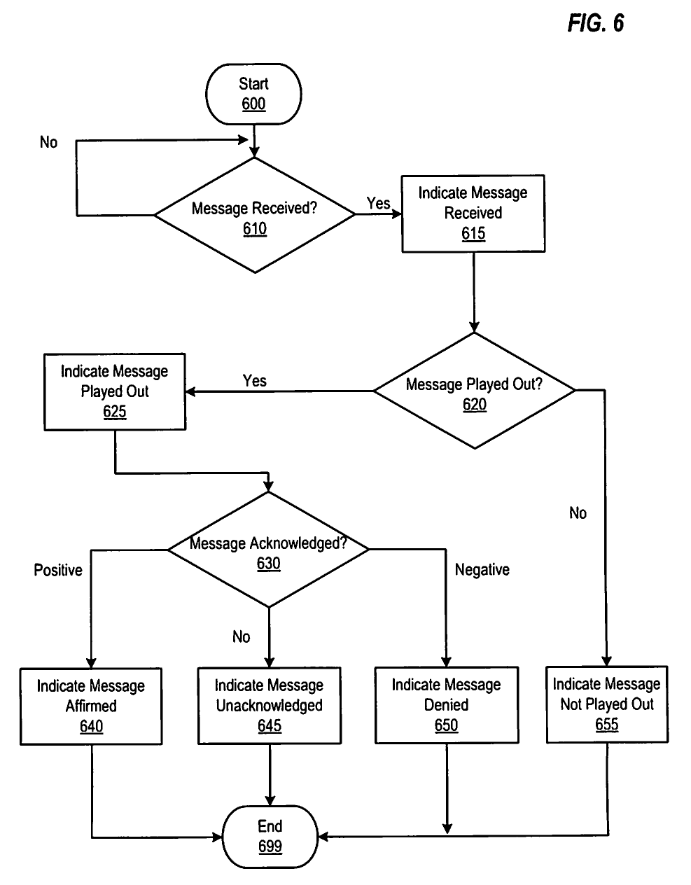

FIG. 6 is a flowchart showing the operation of a device which is an intended receiver of messages, such as computing device 112 of FIG. 3. At operation 610, a receiver detects whether a message is received. A message is transmitted by a sender and typically contains audio, video, or other data. A network interface, for example, a network interface included in interface 304 of FIG. 3, receives a message and communicates the message to a confirmation and acknowledgement module. The confirmation and acknowledgement module indicates, at operation 615, that the message was received. The confirmation and acknowledgement module can interpret a feedback request contained in the message and transmit feedback according to the specifications in the request. Alternatively, the confirmation and acknowledgement module may be configured to provide feedback in a certain way, e.g., using an out-of-band method, or during a specified time window relative to receiving the message.

A computing device, particularly a confirmation and acknowledgement module included therewith, also detects, at operation 620, if a message was accessed, or played out. If a message is played out, the confirmation and acknowledgement module generates and transmits feedback indicating the playout at operation 625. If the message is not played out, the confirmation and acknowledgement module provides feedback indicating no message was played out at operation 655. The confirmation and acknowledgement module has the capability to determine, via a communications interface, if a message was partially played, if there were errors associated with the attempt to play the message, or if the message was not played at all. The confirmation and acknowledgement module generates and transmits feedback which is indicative of each of the above scenarios.

As noted, where there are multiple receivers of a message, the provision of feedback in the operations above may be contingent on the behavior of other receivers of the message. Feedback may be transmitted by a receiver using any of the in-band or out-of-band mechanisms previously discussed, or some combination of those mechanisms. For example, a receiver may send an RTP message indicating a message was received and then provide playout feedback in an RTCP report. The various types of feedback, i.e., reception, playout, and acknowledgement, may each be transmitted separately, utilize the same or different paths, e.g., RTP or RTCP. Alternatively, the types of feedback may be consolidated by a confirmation and acknowledgement module and sent in one or more combined messages utilizing the same or different paths.

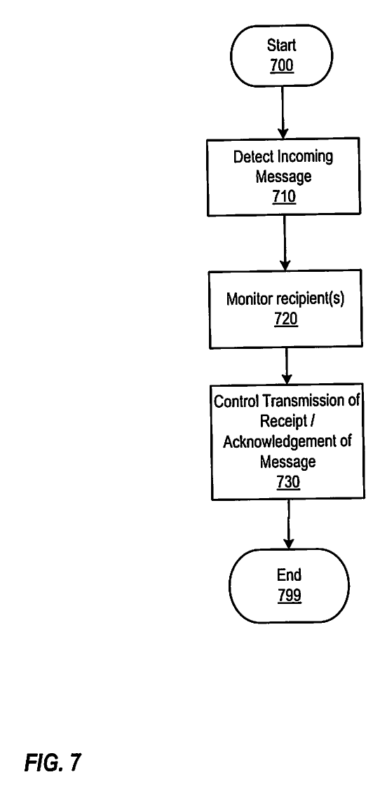

FIG. 7 is a flowchart depicting operation of a monitoring device, such as middlepoint 106 of FIG. 1. At operation 710, the monitoring device detects an incoming message. As discussed with reference to FIG. 6, in one embodiment, the monitoring device may is an intermediate network element. In the case where the intermediate network element operates as a network gateway, all messages sent must pass through the monitoring device. The monitoring device can store information indicating that a message was sent, for example, in a database included with monitoring device. In another embodiment, the monitoring device is a receiver which decodes the addressing of a received message and is thus able to determine which receivers the message was sent to.

At operation 720, the monitoring device monitors receivers to detect which receivers receive the message and provide feedback. This can be accomplished, for example, by polling receivers, or by listening to network channels receivers use to transmit feedback.

The monitoring device, at operation 730, controls transmission of feedback. This may be done by suppressing transmission of feedback by certain receivers or by capturing and filtering transmitted feedback. For example, in the embodiment where the monitoring device is a receiver, the monitoring device may elect to not send feedback if the monitoring device detects that feedback has already been transmitted for a given message. Alternatively, the monitoring device may transmit feedback to a sender of a message, and also transmit a signal to other receivers to not send feedback for the message. In another embodiment, feedback messages may have to traverse monitoring device, for example, if monitoring device acts as a network gateway. In that embodiment, the monitoring device may capture all feedback sent by receivers which corresponds to a given message. The monitoring device can than consolidate the feedback, for example, compiling statistics on the number, identity, and authority levels of receivers who transmitted feedback. The monitoring device can then send an aggregated feedback message to the sender.

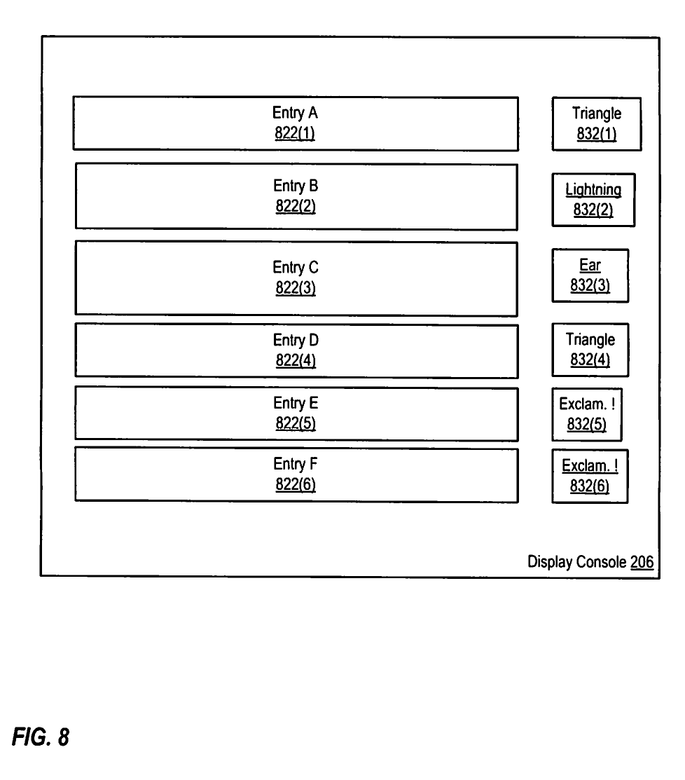

FIG. 8 depicts an example rendering of logged information regarding messages and feedback, such as log information 235 of FIG. 2. When a message is sent by a computing device, details concerning the transmission are captured by a sending module, and stored in data storage. The details concerning a message which can be stored include a message title, destination address, begin transmission time, end transmission time, any priority associated with the message, and the like. When feedback is received from a receiver of a message, details concerning the feedback are stored, for example, in log information 235. The details concerning feedback which can be stored include the time the feedback was received, the message the feedback pertains to, the address of the receiver, a receiver identity, the authority of a receiver, whether the message was accessed (in part or in full), whether a receivers affirms or denies the message, and the like.

A user may access the log information to determine the status of messages. Such information is useful in a variety of contexts, for example, as a forensic tool to determine which messages were received by which receivers, and when the messages were received, as a communications tool to determine whether messages need to be resent or have been heard, and as a network troubleshooting tool to identify areas of impaired network operation.

In one embodiment, the log information is presented to a user via a display console. The log information can be stored in a database and is preferably searchable, for example by keyword or by the date or time a message was sent or feedback was received. A user can enter information identifying one or more messages. The system will retrieve information concerning messages which match the entered information. For example, if a user enters “521”, information concerning message number 521 is retrieved. The information may include any and all information stored, such as when the message was sent, any receivers who received the message, whether the message was affirmed or denied, and the like.

In one embodiment, the display renders the he log information to users as entries. An entry can be configured by an administrator to include information concerning a message and all feedback received in response to the message. For example, an entry, such as entry 822 includes the address of the sender, the time a message was sent, the address the message was sent to, and the priority of the message. Entry 822 also includes information about the reception of the message, such as whether it was received by any receivers, whether it was accessed, and whether it was acknowledged. Entry 822 can also include the identity and authority level of one or more receivers of the message. The status of a message, i.e., received, accessed, acknowledged, may be displayed separately from an entry, for example, in a field such as 832, for quick reference. For example, for a message that was sent but not received, a field 832 can display an icon, for example, a red exclamation point. For a message which has been received and accessed, field 832 can change to display, for example, a green ear. An entry 822 can also be color coded to quickly indicate status to a user.

FIG. 9 shows several examples of payloads for RTP packets. Each payload, such as payload 902, includes several fields. These fields can be modified to carry feedback information. For example, an administrator can define a new event type that indicates that a receiver has played all or a portion of a received message. This event type is included in the event field, e.g., event field 912. The payload can also indicate the duration of time for which the received message has been played, e.g., in duration field 922. A payload also typically includes an end bit field, e.g., end bit field 932, which indicates whether the packet contains the end of the event. If the bit in the end bit field is set to 1, the packet contains the end of the event. If the bit is set to 0, one or more subsequent packets contain additional portion(s) of the event. The payload also includes a volume field, e.g., volume field 942, which indicates the volume of events which can be reproduced as tones. Each payload typically also includes a reserved bit field, e.g., reserved bit field 952, which is set to 0 by senders and ignored by receivers.

FIG. 10 shows how an RTCP report, e.g., RTCP receiver report 1000, can be extended through profiles to provide multiple types of statistics. A profile can be edited, for example, by a system administrator. Receiver reports typically contain a header section, e.g., header 1010, and zero or more reception report blocks, e.g., report block 1020. FIG. 10 shows a receiver report that has been extended to include a play report block 1030. Play report block 1030 specifies not only which packets were received, but which packets were actually played by a receiver. This information can be interpreted, e.g., by feedback module 220, displayed, e.g., via display console 206, and logged, e.g., in log information 235 (all shown in FIG. 2).

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by tile appended claims.

What is claimed is:

1. A method comprising:
detecting whether a transmitted message was received by at least one receiver, wherein the transmitted message was transmitted using a protocol that supports multiple receivers per destination address;
generating an indication of whether the transmitted message was received in response to detecting whether the transmitted message was received; and
causing a user interface to present the indication of whether the transmitted message was received.

2. The method of claim 1, further comprising:
detecting whether content of the transmitted message was provided to a second user interface;
generating an indication of whether content of the transmitted message was provided to the second user interface in response to detecting whether content of the transmitted message was provided to the second user interface; and
causing the first user interface to present the indication of whether content of the transmitted message was provided to the second user interface.

3. The method of claim 1, further comprising:
receiving a reply to the transmitted message;
detecting whether the reply was an affirmation or a denial;
generating an indication of whether the reply was an affirmation or denial in response to detecting whether the reply was an affirmation or denial; and
causing the first user interface to present the indication of whether the reply was an affirmation or denial.

4. The method of claim 2, further comprising:
storing information indicating whether the transmitted message was received and whether content of the transmitted message was provided to the second user interface.

5. The method of claim 1 wherein the detecting comprises receiving an out-of-band message.

6. The method of claim 1 further comprising transmitting an in-band request for feedback.

7. The method of claim 1 wherein the indication is at least one of audible or visual.

8. The method of claim 1, wherein the detecting further comprises:
receiving information from a device, wherein the device monitors the at least one receiver and the device is coupled to at least one of:
the at least one receiver; and
a transmitter of the transmitted message.

9. The method of claim 1, further comprising detecting the authority level of the at least one receiver.

10. The method of claim 1, further comprising detecting the number of receivers based on whether a transmitted message was received by at least one receiver, wherein the detected number is an integer greater than or equal to zero.

11. An apparatus comprising:
a feedback module configured to:
detect whether a transmitted message was received by at least one receiver, wherein the transmitted message was transmitted using a protocol that supports multiple receivers per destination address; and
generate an indication of whether the transmitted message was received in response to detecting whether the transmitted message was received; and
a user interface coupled to the feedback module configured to present the indication of whether the transmitted message was received.

12. The apparatus of claim 11, wherein:
the feedback module is further configured to:
detect whether content of the transmitted message was provided to a second user interface; and
generate an indication of whether content of the transmitted message was provided to the second user interface in response to detecting whether content of the transmitted message was provided to the second user interface; and
the first user interface is further configured to:
present the indication of whether content of the transmitted message was provided to the second user interface.

13. The apparatus of claim 11, wherein:
the feedback module is further configured to:
receive a reply to the transmitted message;
detect whether the reply was an affirmation or a denial; and
generate an indication of whether the reply was an affirmation or denial in response to detecting whether the reply was an affirmation or denial; and
the first user interface is further configured to present the indication of whether the reply was an affirmation or denial.

14. The apparatus of claim 12, further comprising a storage device configured to store information indicating whether the transmitted message was received and whether content of the transmitted message was provided to the second user interface.

15. The apparatus of claim 11, wherein the feedback module is further configured to:
receive an out-of-band message indicating whether the transmitted message was received by at least one receiver.

16. The apparatus of claim 11, further comprising a sending module, wherein the sending module is configured to transmit an in-band request for feedback.

17. The apparatus of claim 11, wherein the feedback module is further configured to:
receive information from a device, wherein the device monitors the at least one receiver and tile device is coupled to at least one of:
the at least one receiver; and
a transmitter of the transmitted message.

18. The apparatus of claim 11, wherein the feedback module is further configured to detect the authority level of the at least one receiver.

19. The apparatus of claim 11, wherein the feedback module is further configured to detect the number of receivers based on whether a transmitted message was received by at least one receiver, wherein the detected number is an integer greater than or equal to zero.

20. An apparatus comprising:
a first means for detecting whether a transmitted message was received by at least one receiver, wherein the transmitted message was transmitted using a protocol that supports multiple receivers per destination address;
a second means for generating an indication of whether the transmitted message was received in response to detecting whether the transmitted message was received; and
a third means for causing a user interface to present the indication of whether the transmitted message was received.
